(19) United States
(12) Patent Application Publication
(10) Pub. No.: US 2025/0068852 A1
(43) Pub. Date: Feb. 27, 2025

(54) INFORMATION SEARCH METHOD, COMPUTER DEVICE, AND STORAGE MEDIUM

(71) Applicant: Beijing Zitiao Network Technology Co., Ltd., Beijing (CN)

(72) Inventors: Aonan TAN, Beijing (CN); Jing LU, Beijing (CN); Ying ZHANG, Beijing (CN)

(21) Appl. No.: 18/793,738

(22) Filed: Aug. 2, 2024

(30) Foreign Application Priority Data
Aug. 25, 2023 (CN) 202311085444.5

(51) Int. Cl. G06F 40/35; G06F 3/04817; G06F 16/332

(52) U.S. Cl. CPC G06F 40/35; G06F 3/04817; G06F 16/3329

(57) ABSTRACT

The present disclosure provides an information search method and apparatus, a computer device, and a storage medium, and the method includes: in response to receiving a question message on an artificial intelligence dialogue interface, acquiring an aggregated answer result matching the question message, the aggregated answer result is determined by content consumption modes corresponding to a message subject scope of the question message, the content consumption modes include a deep consumption mode and a broad consumption mode, and respective answer results in the aggregated answer result obtained in the broad consumption mode are capable of being consumed twice using the deep consumption mode; and displaying the respective answer results comprised in the aggregated answer result on the AI dialogue interface.

### CROSS-REFERENCE TO RELATED APPLICATION

The present application claims the priority to Chinese Patent Application No. 202311085444.5, filed on Aug. 25, 2023, the entire disclosure of which is incorporated herein by reference as portion of the present application.

### TECHNICAL FIELD

The present disclosure relates to an information search method and apparatus, a computer device, and a storage medium.

### BACKGROUND

With the development of artificial intelligence (AI) technology, a variety of intelligent dialogue models begin to emerge, and users can acquire search results provided by the intelligent dialogue models by entering questions on an intelligent dialogue interface. However, on a conventional intelligent dialogue interface, what is displayed is often an aggregation of result websites, and in order to acquire results that satisfy search demands, users need to enter the displayed search website before browsing and filtering the content, which reduces the information search efficiency.

### SUMMARY

Embodiments of the present disclosure at least provide an information search method and apparatus, a computer device, and a storage medium.

In a first aspect, the embodiments of the present disclosure provide an information search method, including:
in response to receiving a question message on an artificial intelligence (AI) dialogue interface, acquiring an aggregated answer result matching the question message, in which the aggregated answer result is determined by content consumption modes corresponding to a message subject scope of the question message, the content consumption modes include a deep consumption mode and a broad consumption mode, and respective answer results in the aggregated answer result obtained in the broad consumption mode are capable of being consumed twice using the deep consumption mode; and
displaying the respective answer results included in the aggregated answer result on the AI dialogue interface.

In an optional embodiment, after displaying the respective answer results included in the aggregated answer result, the method further includes:
displaying a plurality of guiding icons below a target answer result, in which different guiding icons are used for result consumption of the target answer result in different functional dimensions.

In an optional embodiment, the guiding icons include a first icon having a result content interpretation function; and
after displaying the plurality of guiding icons, the method further includes:
acquiring result content interpretation information matching the first icon, in which the result content interpretation information is generated using an AI model according to the target answer result, and is used for parsing the target answer result; and
displaying the result content interpretation information.

In an optional embodiment, the guiding icons include a second icon having an information recommendation function;
after displaying the plurality of guiding icons, the method further includes:
in response to triggering the second icon, acquiring a plurality of recommended question messages associated with the target answer result, in which the recommended question messages are generated using an AI model according to the target answer result and the question message; and
displaying the plurality of recommended question messages; and
after displaying the plurality of recommended question messages, the method further includes:
displaying any recommended question message that is triggered as a new question message on the AI dialogue interface, and displaying a new aggregated answer result matching the new question message.

In an optional embodiment, the guiding icons include a third icon having a result deletion function; and
after displaying the plurality of guiding icons, the method further includes:
in response to triggering the third icon, deleting the target answer result, and updating display positions of respective answer results, other than the target answer result, in the aggregated answer result; or
in response to triggering the third icon, deleting the target answer result and a corresponding associated answer result, and updating display positions of respective answer results, other than the target answer result and the associated answer result, in the aggregated answer result,
in which the associated answer result is an answer result in the aggregated answer result that has a result relevance greater than a preset relevance with the target answer result.

In an optional embodiment, the aggregated answer result is determined by the following steps:
determining a scope index for indicating the message subject scope of the question message according to information semantics of the question message using an AI model; and
in response to the scope index being less than a preset index, aggregating answer results matching the question message from a plurality of information source channels according to the information semantics of the question message, to obtain the aggregated answer result.

In an optional embodiment, the method further includes:
in response to the scope index being greater than or equal to the preset index, determining respective consumption directions corresponding to the question message according to the information semantics of the question message;
generating, for any consumption direction, an answer result matching the consumption direction according to the information semantics; and
determining the aggregated answer result according to answer results matching the respective consumption directions.

In an optional embodiment, the method further includes:
in response to the scope index being greater than or equal to the preset index, filtering out the aggregated answer result from an information list corresponding to a main object indicated by the information semantics of the question message.

In a second aspect, the embodiments of the present disclosure further provide an information search apparatus, including:
an acquisition module, configured to, in response to receiving a question message on an artificial intelligence (AI) dialogue interface, acquire an aggregated answer result matching the question message, in which the aggregated answer result is determined by content consumption modes corresponding to a message subject scope of the question message, the content consumption modes include a deep consumption mode and a broad consumption mode, and respective answer results in the aggregated answer result obtained in the broad consumption mode are capable of being consumed twice using the deep consumption mode;
a display module, configured to display the respective answer results included in the aggregated answer result on the AI dialogue interface.

In a third aspect, the embodiments of the present disclosure further provide a computer device, including a processor and a memory; the memory stores machine-readable instructions executable by the processor, the processor is configured to execute the machine-readable instructions stored in the memory, and when the machine-readable instructions are executed by the processor, the processor performs the above-mentioned first aspect or any one of the embodiments in the first aspect.

In a fourth aspect, the embodiments of the present disclosure further provide a computer-readable storage medium, storing a computer program, and when the computer program is executed by a computer device, the computer device performs the above-mentioned first aspect or any one of the embodiments in the first aspect.

The description of the effects regarding the above-mentioned information search apparatus, computer device, and computer-readable storage medium may be referred to in the explanation of the above-mentioned information search method and will not be repeated here.

For the information search method and apparatus, the computer device, and the storage medium provided in the embodiments of the present disclosure, because the subject scopes are different, the user's search demands are different and the depths of search results expected to be obtained are also different, answer results matching the search demands can be aggregated by determining the content consumption modes according to the subject scope of the question message and by aggregating the answer results in accordance with the corresponding content consumption modes, thus improving the accuracy and rationality of the aggregated answer result. By displaying the respective answer results in the aggregated answer result, the respective answer results can be directly provided to users, and the answer results may be acquired intuitively without an approach of page jumping, which improves the information search efficiency of users. Moreover, with the deep consumption mode and the broad consumption mode provided, two different content consumption frameworks may be provided. After the question message is received, content consumption answers can be achieved by means of the corresponding content consumption frameworks, so that the aggregated answer result can be provided flexibly.

To make the objectives, features and advantages of the present disclosure more comprehensible, the following is a detailed description of preferred embodiments in conjunction with the drawings.

### BRIEF DESCRIPTION OF DRAWINGS

In order to more clearly illustrate the technical solutions of the embodiments of the present disclosure, the drawings required for the embodiments are briefly described below. These drawings are incorporated into and constitute a part of the present disclosure. These drawings illustrate embodiments that comply with the present disclosure and, together with the detailed description, serve to explain the technical solutions of the present disclosure. It should be understood that the following drawings only show some embodiments of the present disclosure and therefore should not be considered as limiting its scope. For those skilled in the art, other related drawings may also be obtained based on these drawings without any creative effort.

FIG. 1 illustrates a flowchart of an information search method according to the embodiments of the present disclosure;

FIG. 2 illustrates a schematic diagram of a display interface of an aggregated answer result according to the embodiments of the present disclosure;

FIG. 3 illustrates a schematic diagram of a display interface of another aggregated answer result according to the embodiments of the present disclosure;

FIG. 4 illustrates a schematic diagram of displaying of guiding icons according to the embodiments of the present disclosure;

FIG. 5 illustrates a schematic diagram of displaying of result content interpretation information according to the embodiments of the present disclosure;

FIG. 6 illustrates a schematic diagram of displaying of recommended question messages according to the embodiments of the present disclosure;

FIG. 7 illustrates a schematic diagram of displaying of target answer result deletion according to the embodiments of the present disclosure;

FIG. 8 illustrates a schematic diagram of an information search apparatus according to the embodiments of the present disclosure; and

FIG. 9 illustrates a schematic structural diagram of a computer device according to the embodiments of the present disclosure.

### DETAILED DESCRIPTION

In order to make the objectives, technical solutions, and advantages of the embodiments of the present disclosure clearer, the technical solutions in the embodiments of the present disclosure will be described clearly and completely below in conjunction with the drawings. Apparently, the described embodiments are just a part but not all of the embodiments of the present disclosure. The components of the embodiments of the present disclosure typically described and illustrated herein can be arranged and designed in a variety of different configurations. Therefore, the detailed description of the embodiments of the present disclosure provided below is not intended to limit the scope of the present disclosure as claimed, but merely represents selected embodiments of the present disclosure. All other embodiments obtained by those skilled in the art without any creative effort based on the embodiments of the present disclosure fall within the scope of the present disclosure.

The terms “first”, “second”, etc. in the embodiments, the claims, and the drawings of the present disclosure are used to distinguish similar objects and are not used to describe a particular order or sequence. It should be understood that the terms so used are interchangeable under appropriate cases, so that the embodiments of the present application may be implemented in an order other than those illustrated or described herein.

The term “multiple or several” as mentioned herein refers to two or more. The term “and/or” describes the associative relationship of related objects, indicating that there may be three types of relationships, for example, A and/or B may indicate three cases including that A exists alone, A and B exist simultaneously, and B exists alone. The character “/” generally indicates that the related objects are in an “or” relationship.

In an intelligent dialogue interface, a user expects to acquire a satisfactory answer result by actively entering a question message, but the current intelligent engine provides search results in which aggregated result websites are often available, and the user needs to enter the displayed result website before browsing and filtering the content, which reduces the information search efficiency of the user.

Based on the above-mentioned research, the present disclosure provides an information search method and apparatus, a computer device and a storage medium. For the information search method and apparatus, the computer device, and the storage medium, because the subject scopes are different, the user's search demands are different and the depths of search results expected to be obtained are also different, answer results matching the search demands can be aggregated by determining the content consumption modes according to the subject scope of the question message and by aggregating the answer results in accordance with the corresponding content consumption modes, thus improving the accuracy and rationality of the aggregated answer result. By displaying the respective answer results in the aggregated answer result, the respective answer results can be directly provided to users, and the answer results may be acquired intuitively without an approach of page jumping, which improves the information search efficiency of users. Moreover, with the deep consumption mode and the broad consumption mode provided, two different content consumption frameworks may be provided. After the question message is received, content consumption answers can be achieved by means of the corresponding content consumption frameworks, so that the aggregated answer result can be provided flexibly.

The defects of the above-mentioned solution are the result of the inventor's practice and careful study, and therefore, the process of discovering the above-mentioned problems and the solutions proposed in the present disclosure below to address the above-mentioned problems should be the inventor's contribution to the present disclosure in the course of the present disclosure.

It should be noted that similar numerals and letters denote similar items in the drawings, and therefore, once an item is defined in a figure, it does not need to be further defined or explained in the subsequent figures.

It may be understood that before using the technical solutions disclosed in the embodiments of the present disclosure, it is necessary to inform user(s) the types, using scope, and using scenarios of personal information involved in the present disclosure according to relevant laws and regulations in an appropriate manner and obtain the authorization of the user(s).

In order to facilitate the understanding of the present disclosure, an information search method disclosed in the embodiments of the present disclosure is first described in detail. The information search method provided in the embodiments of the present disclosure is generally executed by a terminal device or other processing device having certain computing power. The terminal device may be UE (User Equipment), a mobile device, a user terminal, a terminal, a PDA (Personal Digital Assistant), a handheld device, a computing device, and the like. In some possible implementations, the information search method may be implemented by a processor calling computer-readable instructions stored in a memory.

The information search method provided in the embodiments of the present disclosure is described below by taking an example in which the execution subject is a computer device.

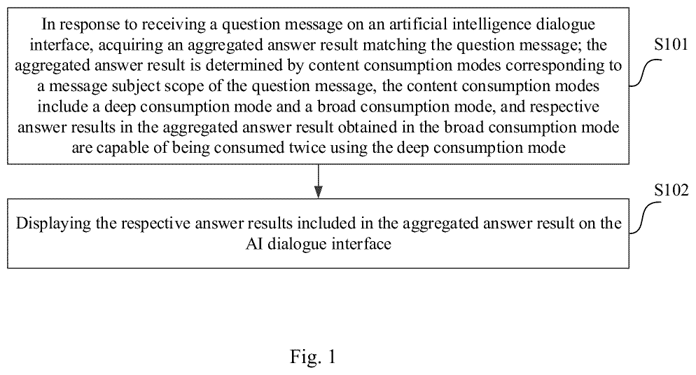

A flowchart of an information search method according to the embodiments of the present disclosure is illustrated in FIG. 1, which may include the following steps.

S101: in response to receiving a question message on an artificial intelligence dialogue interface, acquiring an aggregated answer result matching the question message; the aggregated answer result is determined by content consumption modes corresponding to a message subject scope of the question message, the content consumption modes include a deep consumption mode and a broad consumption mode, and respective answer results in the aggregated answer result obtained in the broad consumption mode are capable of being consumed twice using the deep consumption mode.

Here, the artificial intelligence (AI) dialogue interface may be an interface provided by an application developed based on an AI model. When a user enters a question message on the AI dialogue interface, answer results for the question message may be provided by means of the AI model and displayed to the user, and such a question-and-answer process may be referred to as a round of dialogue.

The question message may be a question entered by the user according to his/her search demand. For example, the question message may be “What are the recent hot news”, “Help me write an article XX”, “How to solve the problem XX” and the like. Different question messages have different subject scopes. The subject scope is used to characterize clarity of a question subject of the question message, the higher clarity of the question subject leading to the smaller subject scope. In different subject scopes, the user expects different levels of consumption of the question message. In response to a small subject scope, the user often needs deep consumption of the question message to acquire deep answer results for the question message to satisfy the search demand. Conversely, in response to a large subject scope, the consumption subject is often less clear, so the search demand may be satisfied by performing broad consumption on the question message.

The deep consumption mode is an approach for deep consumption of the search results and the question message, and the broad consumption mode is an approach for broad consumption of the search results and the question message. The difference between deep consumption and broad consumption is that the respective answer results obtained in the deep consumption mode are finer-grained answer results, and the respective answer results are obtained after longitudinal consumption of the question message, and also belong to answer results in the same vertical domain. The respective answer results obtained in the broad consumption mode are coarser-grained answer results. One answer result often corresponds to one vertical domain, and different answer results correspond to different vertical domains. A plurality of answer results are obtained after horizontal consumption of the question message, and the respective answer results may further be consumed twice using the deep consumption mode.

Illustratively, in response to the question message referring to the rainstorm in XX region, the subject scope of the question message is very clear, i.e., “The rainstorm in XX region”, therefore, an aggregated answer result related to the question message may be acquired using the deep consumption mode. For example, the aggregated answer result may include “News about the rainstorm in XX region”, “Impact of the rainstorm in XX region”, “Currently latest situation”, “Various response measures and policies”, etc., which belong to the same vertical domain. However, when the question message is “The recent hot events”, due to the large subject scope of the question message, an aggregated answer result related to the question message may be acquired using the broad consumption mode. For example, the aggregated answer result may include “The rainstorm in XX region”, “News about XXXX”, “XX product launch”, “XX movie publicity”, “XX military news”, “XX sports news” and other answer results belonging to different vertical domains, each of which may also be subjected to deep consumption. Here, a vertical domain may also be called a category.

The aggregated answer result may be the answer results for answering the question message, which may include a plurality of answer results with different result contents. The plurality of answer results all match the question message. The aggregated answer result may specifically be generated using the AI model in accordance with content consumption modes corresponding to the subject scope of the question message. The content consumption modes may include the deep consumption mode and the broad consumption mode. Even for the same question message, the aggregated answer result obtained in different content consumption modes will be different. The respective answer results in the aggregated answer result obtained in the deep consumption mode may be more specific results, and the respective answer results in the aggregated answer result obtained in the broad consumption mode may be more generalized results.

Optionally, the aggregated answer result obtained using the broad consumption mode may include answer results corresponding to different vertical domains obtained in the broad consumption mode, and may also include the respective answer results obtained after each answer result is subjected to secondary deep consumption. That is, the aggregated answer result obtained using the broad consumption mode include two parts, one part being a plurality of answer results obtained by broad consumption, and the other part being a plurality of answer results obtained after each answer result is subjected to secondary deep consumption.

In a specific implementation, when the user has a search demand, he/she can enter a question message on the AI dialogue interface, and a client may send the question message to a server in response to receiving the question message. After receiving the question message, the server may input the question message into an AI model. The AI model may perform semantic recognition on the question message to determine a subject scope corresponding to the question message, so as to perform content consumption on the question message in accordance with the content consumption mode corresponding to the subject scope and to output an aggregated answer result matching the question message. Then, the server may feed back the aggregated answer result output from the AI model to the client such that the client acquires the aggregated answer result.

Illustratively, in response to the question message being “The latest military news of A and B”, the aggregated answer result acquired may be N answer results most relevant to the question message obtained using the deep consumption mode, where N is a positive integer greater than or equal to 0. In response to the question message being “Latest military news worth paying attention to recently”, the aggregated answer result acquired may be the answer results in a plurality of vertical domains that are obtained using the broad consumption mode and match the question message. The plurality of answer results may include one probabilistic answer result related to “The latest military news of A and B”. Optionally, in response to the question message being “Latest military news worth paying attention to recently”, the aggregated answer result may not only include the answer results in a plurality of vertical domains, but also include a secondary aggregated result obtained after the secondary deep consumption of the answer results in each vertical domain. The answer results in a vertical domain correspond to a secondary aggregated result, and the secondary aggregated result may include N answer results in the corresponding vertical domain.

In an embodiment, the aggregated answer result may be determined by the following steps:
Step 1: determining a scope index for indicating the message subject scope of the question message according to information semantics of the question message using an AI model.

Here, the scope index is used to indicate the size of the subject scope, and the smaller scope index leads to the smaller subject scope and the clearer subject. Conversely, the larger scope index leads to the larger subject scope and the more ambiguous subject. The scope index may be determined according to the information semantics and the number of main objects in the question message. The main objects are specific objects in the question message, for example, in response to the question message being “The latest military news of A and B”, the main objects may include “A”, “B” and “military news”; and in response to the question message being “Latest military news worth paying attention to recently”, the main object may include “military news” only.

In a specific implementation, the AI model may be used to perform semantic recognition on the question message to determine the information semantics of the question message and the number of main objects in the question message. Then, the scope index for indicating the subject scope of the question message may be determined according to the information semantics and the number of main objects.
Step 2: in response to the scope index being less than a preset index, aggregating answer results matching the question message from a plurality of information source channels according to the information semantics of the question message, to obtain the aggregated answer result.

Here, the information source channels may include a variety of authorized information websites, and each information source channel may provide a large amount of multimedia information, such as graphic information and video information. The answer results matching the question message are the multimedia information matching the question message.

Each answer result in the aggregated answer result may be a certain answer result matching the question message in the information source channel, or may be a result obtained after information aggregation of a plurality of answer results matching the question message in at least one information source channel. The preset index may be set by experience, which is not specifically limited in the embodiment of the present disclosure.

In a specific embodiment, after the scope index is determined, it may be determined whether the scope index is less than the preset index, and if so, it means that the question message has a clear subject, and the result aggregation may be performed using the deep consumption mode. Specifically, answer results matching the question message may be acquired from a plurality of information source channels using the deep consumption mode, and then, the plurality of matching answer results may be aggregated in accordance with the subject scope to obtain the aggregated answer result.

Conversely, in response to the scope index being greater than or equal to the preset index, it means that the question message has a vague subject scope, and the result aggregation may be performed using the broad consumption mode. Specifically, the broad consumption mode may be specifically be either of the following:
Mode 1: in response to the scope index being greater than or equal to the preset index, determining respective consumption directions corresponding to the question message according to the information semantics of the question message;
generating, for any consumption direction, an answer result matching the consumption direction according to the information semantics; and
determining the aggregated answer result according to answer results matching the respective consumption directions.

Here, one consumption direction may correspond to one vertical domain, and the consumption direction may be related to a classified subject under a subject corresponding to the question message. For example, in response to the subject being military, the classified subject may be aviation military, land military, military of XX region, national military/foreign military, hot military, etc. One consumption direction may match one answer result. The answer result corresponds to one vertical domain. The scope index of the answer result matching each consumption direction is less than the preset index.

In a specific implementation, in response to the scope index being greater than or equal to the preset index, the AI model may be used to determine the respective consumption directions related to the question message according to the information semantics of the question message. Then, for each consumption direction, the respective answer results in the consumption direction may be acquired from the respective information channels, and the AI model may be used for aggregating the respective answer results to obtain one answer result matching the consumption direction. Then, the answer results matching the respective consumption directions may be combined to obtain the aggregated answer result.

Alternatively, after the answer results matching the respective consumption directions are obtained, the AI model may also be used to perform deep consumption on the answer results in the deep consumption mode to obtain a secondary aggregated result corresponding to the answer results. Then, the answer results matching the respective consumption directions and the secondary aggregated result of each answer result may be combined to obtain the aggregated answer result.
Mode 2: in response to the scope index being greater than or equal to the preset index, filtering out the aggregated answer result from an information list corresponding to a main object indicated by the information semantics of the question message.

Illustratively, the main object may be, for example, military, sports, recreation and pictures, and the main object may have a corresponding information list, for example, a military list, a sports list, a recreation list, and a picture list.

In a specific implementation, in response to the scope index being greater than or equal to the preset index, the respective main objects included in the question message may be determined according to the information semantics of the question message. Then, a target main object having a corresponding information list may be filtered out from the main objects. For each target main object, the top M list results may be filtered out from the information list corresponding to the target main object. Then, the top M list results filtered out corresponding to each target main object may be combined to obtain the aggregated answer result.

Alternatively, in response to the question message including a plurality of main objects, the most important one of the target main objects may be determined according to the information semantics, and the top M list results in the information list corresponding to this target main object may be combined to obtain the aggregated answer result. M is a positive integer greater than or equal to 2.

S102: displaying the respective answer results included in the aggregated answer result on the AI dialogue interface.

In a specific implementation, after acquiring the aggregated answer result matching the question message, the client may sequentially display the respective answer results included in the aggregated answer result on the AI dialogue interface. Specifically, the respective answer results included in the aggregated answer result may be displayed below the question message.

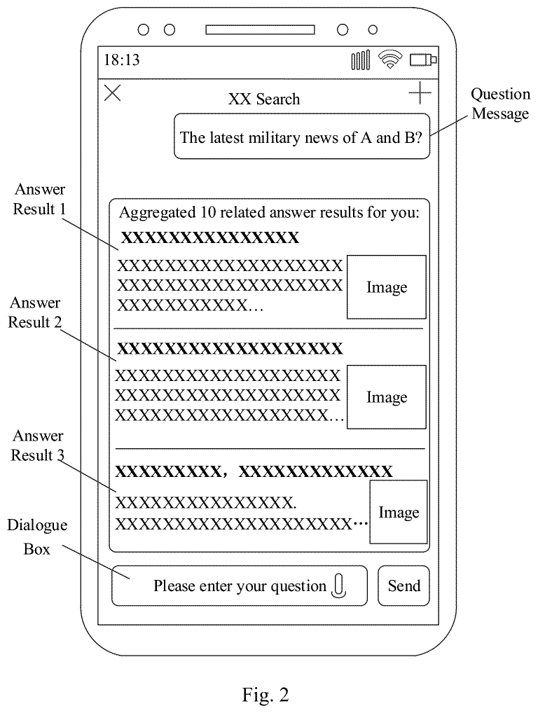

FIG. 2 illustrates a schematic diagram of a display interface of an aggregated answer result according to the embodiments of the present disclosure. In FIG. 2, the question message is “The latest military news of A and B”, and 10 answer results are included in the aggregated answer result, but due to the size limitation of the interface, only 3 answer results (answer results 1 to 3) are displayed. The client may display other results by responding to a page swipe operation. Also illustrated in FIG. 2 is a dialogue box in which the user may enter a new question message to initiate a new round of question and answer.

Optionally, in response to that the aggregated answer result is obtained using the broad consumption mode and includes secondary aggregated answer result corresponding to the answer results in each vertical domain, the answer results in each vertical domain may be displayed only on the AI dialogue interface; and in response to triggering any of the answer results, details of this answer result and the respective answer results in the secondary aggregated answer result corresponding to the answer result may be displayed. Alternatively, the answer results in each vertical domain and the respective answer results in the secondary aggregated answer result corresponding to any answer result may be displayed on the AI dialogue interface only.

Alternatively, in response to that the aggregated answer result is obtained using the broad consumption mode and includes the secondary aggregated answer result corresponding to the answer results in each vertical domain, tag information corresponding to the answer results in each vertical domain may be acquired, and the tag information, an answer result corresponding to a selected tag, and a secondary aggregated result corresponding to the answer result, may be displayed on the dialogue interface. For example, in response to that the answer results in each vertical domain are answer results 4 to 7, the tag information corresponding to the answer results 4 to 7 are tags 1 to 4, and the selected tag is tag 1, the tags 1 to 4 may be displayed below the question message, and the answer result 4 corresponding to the tag 1 and the respective answer results in the secondary aggregated result corresponding to the answer result 4 may be displayed.

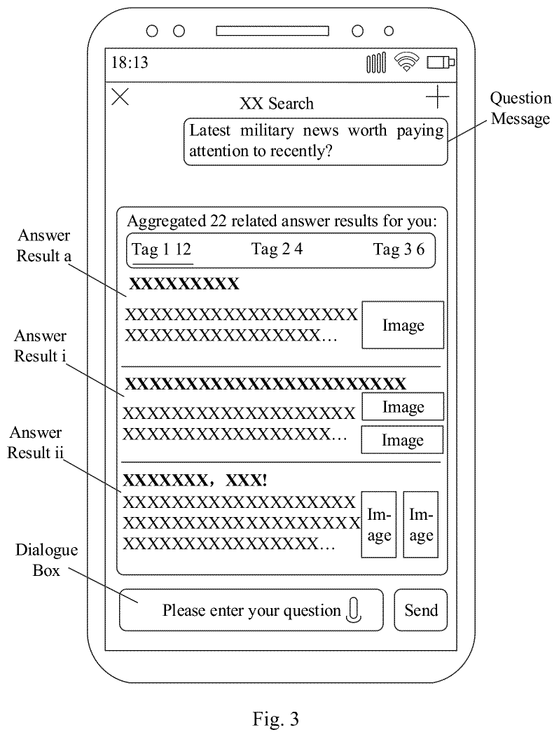

FIG. 3 illustrates a schematic diagram of a display interface of another aggregated answer result according to the embodiments of the present disclosure. In FIG. 3, the question message is “Latest military news worth paying attention to recently”, and the aggregated answer result includes answer results a-c corresponding to vertical domains 1-3, respectively. In FIG. 3, vertical tags (i.e., tags 1-3) respectively corresponding to the answer results a-c are displayed, the selected tag is tag 1, so the answer result a and its corresponding secondary aggregated result are also displayed in FIG. 3. The secondary aggregated result includes 12 answer results in the vertical domain 1, and answer results i and ii are also displayed in FIG. 3. The number after each tag indicates the total number of answer results under that tag. The total number is equal to the number of answer result (which is 1) plus the number of results in the secondary aggregated result corresponding to the answer result.

In this way, because the subject scopes are different, the user's search demands are different and the depths of search results expected to be obtained are also different, answer results matching the search demands can be aggregated by determining the content consumption modes according to the subject scope of the question message and by aggregating the answer results in accordance with the corresponding content consumption modes, thus improving the accuracy and rationality of the aggregated answer result. By displaying the respective answer results in the aggregated answer result, the respective answer results can be directly provided to users, and the answer results may be acquired intuitively without an approach of page jumping, which improves the information search efficiency of users. Moreover, with the deep consumption mode and the broad consumption mode provided, two different content consumption frameworks may be provided. After the question message is received, content consumption answers can be achieved by means of the corresponding content consumption frameworks, so that the aggregated answer result can be provided flexibly.

Further, after the aggregated answer result is displayed, in response to a triggering operation of any target answer result included in the aggregated answer result of the user, detailed information of the target answer result may be displayed. The approach of displaying the detailed information of the target answer result may refer to jumping to a detail page, or may refer to displaying the result directly on the AI dialogue interface.

In an embodiment, after the respective answer results included in the aggregated answer result are displayed, a plurality of guiding icons may be displayed below a target answer result; and the different guiding icons are used for result consumption of the target answer result in different functional dimensions.

Here, the target answer result may be any answer result that is triggered to display the detail information, or any answer result in the aggregated answer result that is subjected to a preset operation. For example, the preset operation may be, for example, triggering a preset icon, triggering a preset gesture, and clicking on an answer result.

Different guiding icons have different result consumption capabilities and are used for the result consumption of the target answer result in different functional dimensions. The functional dimensions may be, for example, a result content interpretation dimension, a question message recommendation dimension, a result deletion and blacklist dimension, and a result refresh dimension. The number of the guiding icons and their result consumption capabilities may be set by experience, which are not specifically limited in the embodiments of the present disclosure.

Illustratively, a plurality of guiding icons may be displayed below the target answer result in response to a guide triggering operation for the target answer result.

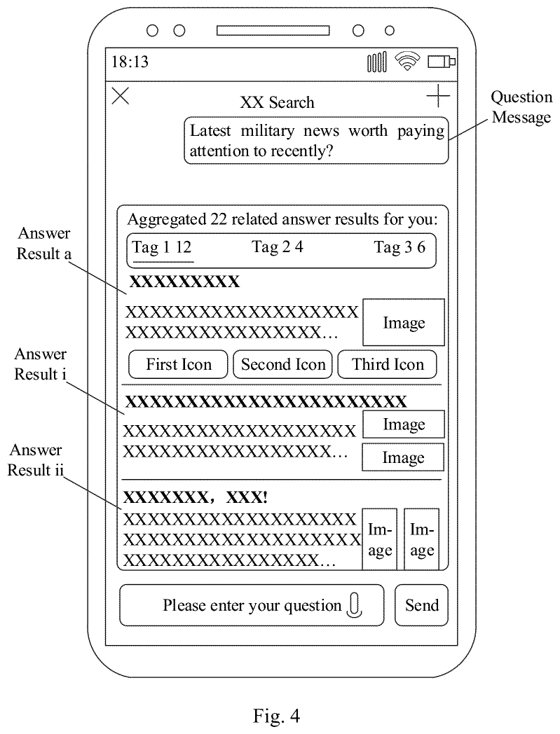

FIG. 4 illustrates a schematic diagram of displaying of guiding icons according to the embodiments of the present disclosure. In FIG. 4, the target answer result is the answer result a in FIG. 3, and three guiding icons (i.e., a first icon, a second icon, and a third icon) are displayed below the answer result a.

In an embodiment, the guiding icons may include a first icon having a result content interpretation function and used for deep parsing the target answer result in the result content interpretation dimension. For example, the first icon may be an icon of “Deep interpretation of the result”.

After the plurality of guiding icons are displayed, result content interpretation information matching the first icon may be acquired and then the result content interpretation information is displayed. The result content interpretation information is generated using an AI model according to the target answer result and is used for parsing the target answer result.

Here, the result content interpretation information is information obtained after deep interpretation of the target answer result using an AI model, which can be used to parse the target answer result, helping the user to acquire more deep information related to the target answer result.

In a specific implementation, the result content interpretation information obtained after the deep interpretation of the target answer result by means of the AI model may be acquired in response to the triggering operation for the first icon. Then, the result content interpretation information may be displayed below the target answer result, and display positions of other answer results may be adaptively adjusted.

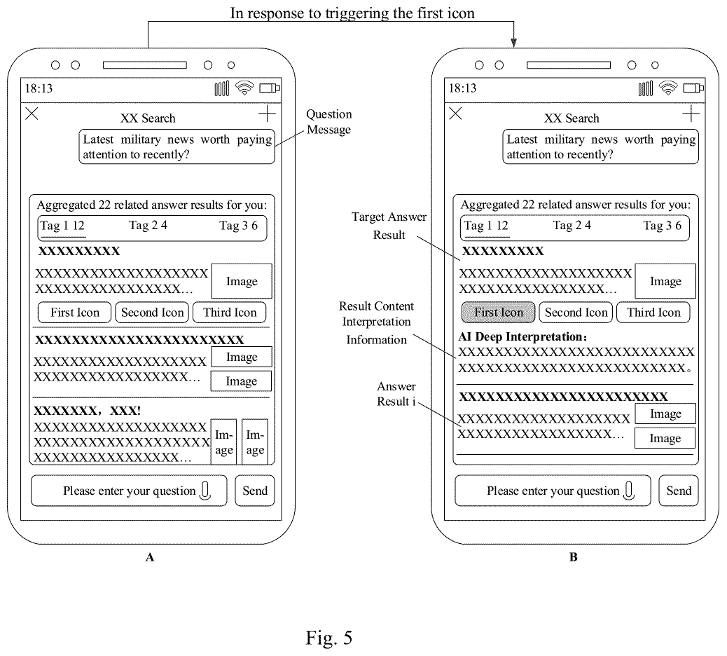

FIG. 5 illustrates a schematic diagram of displaying of result content interpretation information according to the embodiments of the present disclosure. A of FIG. 5 is FIG. 4. An interface illustrated as B of FIG. 5 may be displayed in response to triggering a first icon in A. Result content interpretation information for a target answer result is displayed below the target answer result in B. Also displayed below the target answer result is answer result i in the secondary aggregated result.

In an embodiment, the guiding icons may include a second icon having an information recommendation function, which is used for recommending at least one recommended question message related to the target answer result in the question message recommendation dimension. For example, the second icon may be an icon of “View expanded content”.

After the plurality of guiding icons are displayed, in response to triggering the second icon, a plurality of recommended question messages associated with the target answer result may be acquired and the plurality of recommended question messages are displayed. The recommended question messages are generated using an AI model according to the target answer result and the question message.

Here, the recommended question messages are question messages associated with the target answer result, which are different from the question message input by the user, and may be question messages used for asking further questions about the content of the target answer result, or may be some question messages associated with the specific content of the question message and the target answer result. For example, in response to the target answer result including object 1 and object 2, the recommended question messages may be question messages associated with the object 1 and the object 2, respectively.

In a specific implementation, after the plurality of guiding icons are displayed, a plurality of recommended question messages generated using an AI model according to the question message and the target answer result may be acquired in response to triggering the second icon of the plurality of guiding icons. The plurality of recommended question messages may then be displayed below the target answer result, and display positions of the other answer results may be adaptively adjusted.

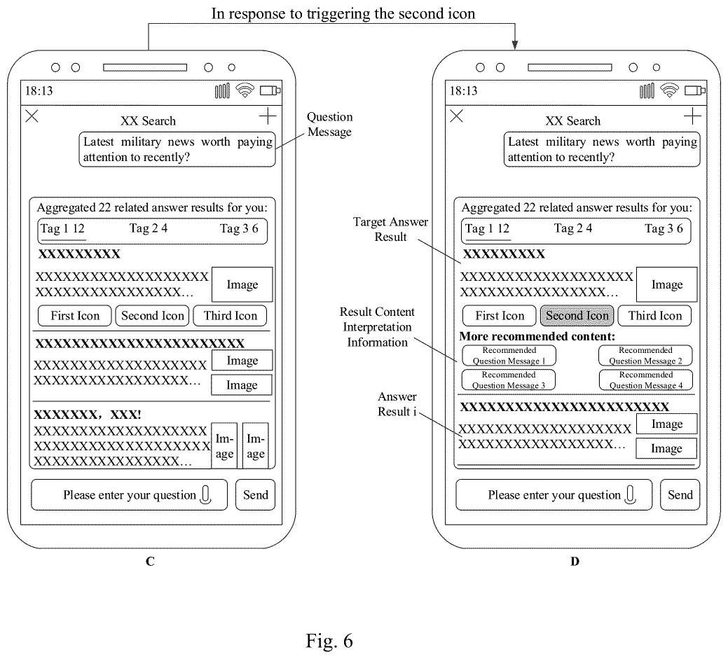

FIG. 6 is a schematic diagram of displaying of recommended question messages according to the embodiments of the present disclosure. C of FIG. 6 is FIG. 4. In response to triggering a second icon in C, an interface as illustrated in D of FIG. 6 may be displayed; and a plurality of recommended question messages (i.e., recommended question messages 1 to 4 in D of FIG. 6) related to the target answer result are displayed below the target answer result in D of FIG. 6.

Further, after the recommended question messages are displayed, any recommended question message that is triggered as a new question message may be displayed on the AI dialogue interface, and a new aggregated answer result matching the new question message may be displayed.

Here, the new aggregated answer result may be an aggregated answer result that matches a new question message and is generated using an AI model in accordance with a content consumption mode that matches a subject scope corresponding to the new question message.

In a specific implementation, after the recommended question messages are displayed, in response to a triggering operation for any recommended question message, the recommended question message may be sent to a server as a new question message enabling the server to output a corresponding new aggregated answer result using the AI model and provide feedback. Moreover, the new question message may be displayed below the aggregated answer result displayed currently.

Then, after acquiring the new aggregated answer result for answering the new question message, the client may display the new aggregated answer result below the new question message. In this way, a new round of dialogue may be completed.

In an embodiment, the guiding icons may further include a third icon having a result deletion function for deleting at least the displayed target answer result in the result deletion and blacklist dimension. The third icon may be an icon of “Not interested”.

Specifically, after the plurality of guiding icons are displayed, the third icon may be utilized to perform at least one of the following two operations:
Operation 1: in response to triggering the third icon, deleting the target answer result, and updating display positions of respective answer results, other than the target answer result, in the aggregated answer result.

In a specific implementation, in response to a triggering operation on the third icon, the target answer result displayed on the AI dialogue interface may be deleted and display positions of the respective answer results that are located after the target answer result may be adjusted adaptively. Alternatively, the target answer result displayed on the AI dialogue interface may be deleted, and the display positions of the respective answer results may be rearranged according to result relevance between the target answer result and the respective answer results, other than the target answer result, in the aggregated answer result, and these answer results may be displayed on the AI dialogue interface in accordance with the rearranged display positions.
Operation 2: in response to triggering the third icon, deleting the target answer result and a corresponding associated answer result, and updating display positions of respective answer results, other than the target answer result and the associated answer result, in the aggregated answer result; here, the associated answer result is an answer result in the aggregated answer result that has a result relevance greater than a preset relevance with the target answer result.

Here, the preset relevance may be set by experience, which is not specifically limited in the embodiments of the present disclosure. The result relevance is used to indicate a degree of content repetition and/or a degree of content relevance between two answer results.

In a specific implementation, in response to triggering the third icon, the server may be utilized to determine, from the aggregated answer result, the respective associated answer results that have the result relevance with the target answer result that is greater than the preset correlation. Then, the target answer result and the respective associated answer results displayed on the AI dialogue interface may be deleted. Moreover, the display positions of respective answer result, other than the target answer result and the associated answer results, in the aggregated answer result may be adaptively adjusted.

In addition, after the third icon is triggered, the recommendation of answer results similar to the target answer result may be reduced in the subsequent process of providing the user with the aggregated answer result.

It should be noted that in response to the target answer result being an answer result corresponding to a certain vertical domain and obtained in the broad consumption mode, the target answer result and the secondary aggregated result corresponding thereto may be deleted in response to triggering the target answer result, that is, each answer result of the secondary aggregated result corresponding to the target answer result will be used as an associated answer result of the target answer result. At this point, an answer result corresponding to another vertical domain and a secondary aggregated result corresponding to the answer result may be displayed. For example, when the target answer result is the answer result a in FIG. 4, in response to triggering the third icon, the answer result a and a secondary aggregated result corresponding to the answer result a are deleted. Moreover, the answer result b and a secondary aggregated result corresponding to the answer result b are displayed on the AI dialogue interface.

When the target answer result is any answer result obtained in the deep consumption mode, in response to triggering the third icon, the associated answer result and the target answer result in the aggregated answer result obtained in the deep consumption mode may be deleted, and display positions of the other answer results may be adjusted adaptively.

When the target answer result is any answer result in the secondary aggregated result, in response to triggering the third icon, the associated answer result and the target answer result in the secondary aggregated result may be deleted, and display positions of the other answer results in the secondary aggregated result may be adaptively adjusted.

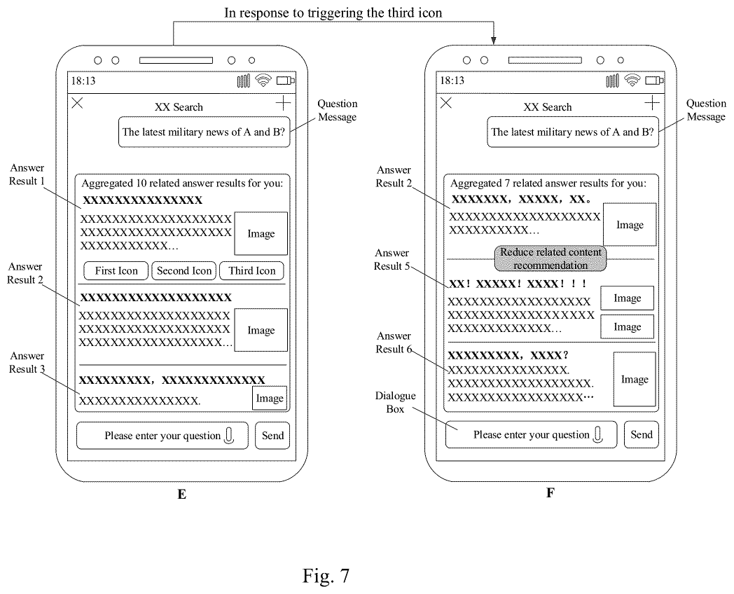

FIG. 7 illustrates a schematic diagram of displaying of target answer result deletion according to the embodiments of the present disclosure, and E in FIG. 7 is a schematic diagram of displaying a plurality of guiding icons below the answer result 1 in FIG. 2. In response to triggering the third icon in E, an interface as illustrated in F of FIG. 7 is displayed. In F, the target answer result and the associated answer results have been deleted, and the associated answer results may be answer result 3 and answer result 4. Moreover, display positions of the other answer results may be adaptively adjusted, and after the display positions are adjusted, answer result 2, answer result 5 and answer result 6 are displayed in F of FIG. 7. In addition, a prompt message of “Reduce related content recommendation” is also displayed in F of FIG. 7.

Those skilled in the art may understand that, in the specific implementations of the above-mentioned methods, the writing order of the steps does not imply a strict order of execution and does not constitute any limitation of the implementation process, and the specific execution order of the steps should be determined by its function and possible internal logic.

Based on the same inventive concept, the embodiments of the present disclosure further provide an information search apparatus corresponding to the information search method. Because the apparatus in the embodiments of the present disclosure solves the problem in a similar way to the information search method in the embodiments of the present disclosure, the implementation of the apparatus may refer to the implementation of the method, and repeated descriptions are omitted.

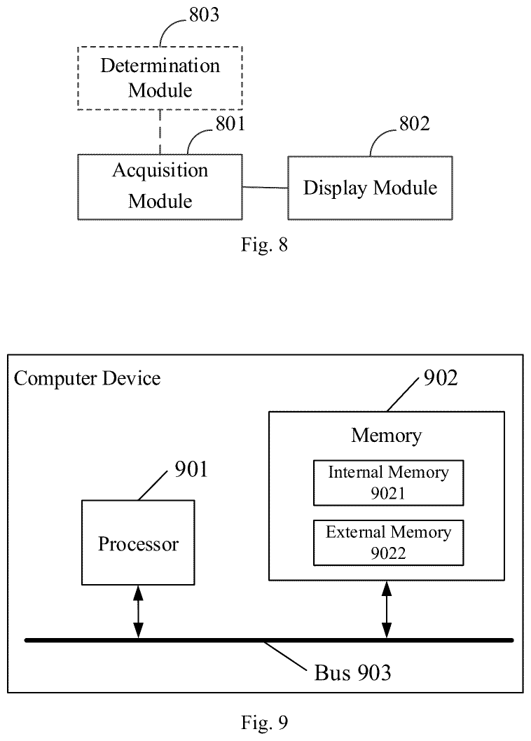

FIG. 8 illustrates a schematic diagram of an information search apparatus according to the embodiments of the present disclosure. The information search apparatus includes:
an acquisition module 801, configured to, in response to receiving a question message on an artificial intelligence (AI) dialogue interface, acquire an aggregated answer result matching the question message; and the aggregated answer result is determined by content consumption modes corresponding to a message subject scope of the question message, the content consumption modes include a deep consumption mode and a broad consumption mode, and respective answer results in the aggregated answer result obtained in the broad consumption mode are capable of being consumed twice using the deep consumption mode; and
a display module 802, configured to display the respective answer results included in the aggregated answer result on the AI dialogue interface.

In a possible implementation, the determination module 802, after displaying the respective answer results included in the aggregated answer result, is further configured to:
display a plurality of guiding icons below a target answer result, in which different guiding icons are used for result consumption of the target answer result in different functional dimensions.

In a possible implementation, the guiding icons include a first icon having a result content interpretation function;
the acquisition module 801, after the plurality of guiding icons are displayed, is further configured to:
acquire result content interpretation information matching the first icon, in which the result content interpretation information is generated using an AI model according to the target answer result, and is used for parsing the target answer result; and
the display module 802, after displaying the plurality of guiding icons, is further configured to:
display the result content interpretation information.

In a possible implementation, the guiding icons include a second icon having an information recommendation function;
the acquisition module 801, after the plurality of guiding icons are displayed, is further configured to:
in response to triggering the second icon, acquire a plurality of recommended question messages associated with the target answer result, in which the recommended question messages are generated using an AI model according to the target answer result and the question message; and
the display module 802, after displaying the plurality of guiding icons, is further configured to:
display the plurality of recommended question messages; and display any recommended question message that is triggered as a new question message on the AI dialogue interface, and display a new aggregated answer result matching the new question message.

In a possible implementation, the guiding icons include a third icon having a result deletion function;
the display module 802, after displaying the plurality of guiding icons, is further configured to:
in response to triggering the third icon, delete the target answer result, and update display positions of respective answer results, other than the target answer result, in the aggregated answer result; or
in response to triggering the third icon, delete the target answer result and a corresponding associated answer result, and update display positions of respective answer results, other than the target answer result and the associated answer result, in the aggregated answer result;
here, the associated answer result is an answer result in the aggregated answer result that has a result relevance greater than a preset relevance with the target answer result.

In an optional implementation, the apparatus further includes:
a determination module 803, configured to determine the aggregated answer result by the following steps:
determining a scope index for indicating the message subject scope of the question message according to information semantics of the question message using an AI model;
and
in response to the scope index being less than a preset index, aggregating answer results matching the question message from a plurality of information source channels according to the information semantics of the question message, to obtain the aggregated answer result.

In a possible implementation, the determination module 803 is further configured to:
in response to the scope index being greater than or equal to the preset index, determining respective consumption directions corresponding to the question message according to the information semantics of the question message;
generating, for any consumption direction, an answer result matching the consumption direction according to the information semantics; and
determining the aggregated answer result according to answer results matching the respective consumption directions.

In a possible implementation, the determination module 803 is further configured to:
in response to the scope index being greater than or equal to the preset index, filtering out the aggregated answer result from an information list corresponding to a main object indicated by the information semantics of the question message.

The descriptions of processing flows of the modules and the interaction flows between the modules in the apparatus may be referred to the relevant descriptions in the above-mentioned method embodiments, and will not be described in detail herein.

Based on the same technical concept, the embodiments of the present disclosure further provide a computer device. FIG. 9 is a schematic structural diagram of a computer device according to the embodiments of the present disclosure. The computer device includes:
a processor 901, a memory 902 and a bus 903; the memory 902 stores machine-readable instructions executable by the processor 901, the processor 901 is configured to execute the machine-readable instructions stored in the memory 902, and when the machine-readable instructions are executed by the processor 901, the processor 901 performs the following steps: S101: in response to receiving a question message on an artificial intelligence dialogue interface, acquiring an aggregated answer result matching the question message; the aggregated answer result is determined by content consumption modes corresponding to a message subject scope of the question message, the content consumption modes include a deep consumption mode and a broad consumption mode, and respective answer results in the aggregated answer result obtained in the broad consumption mode are capable of being consumed twice using the deep consumption mode; and S102: displaying the respective answer results included in the aggregated answer result on the AI dialogue interface.

The memory 902 includes an internal memory 9021 and an external memory 9022. The internal memory 9021, also referred to as an internal storage, is used for temporary storage of computing data in the processor 901, as well as data exchanged with the external memory 9022, such as a hard disk. The processor 901 exchanges data with the external memory 9022 through the internal memory 9021. When the computer device is in operation, the processor 901 communicates with the memory 902 via the bus 903 such that the processor 901 executes the execution instructions referred to in the method embodiments above.

The embodiments of the present disclosure further provide a computer-readable storage medium, and the computer-readable storage medium stores a computer program. When the computer program is run by a processor, the information search method described in the method embodiments above are performed. The storage medium may be a volatile or non-volatile computer-readable storage medium.

A computer program product using the information search method provided in the embodiments of the present disclosure includes a computer-readable storage medium storing program code; the program code includes instructions that may be configured to execute the information search method described in the above-mentioned method embodiments, which may be specified in the above-mentioned method embodiments, and will not be repeated herein.

The computer program product may be implemented specifically by means of hardware, software or a combination thereof. In an optional embodiment, the computer program product is specifically embodied as a computer storage medium, and in another optional embodiment, the computer program product is specifically embodied as a software product, such as an SDK (Software Development Kit), and the like.

It may be clearly understood by those skilled in the art that, for the purpose of convenient and brief description, for a detailed working process of the foregoing system and apparatus, reference may be made to a corresponding process in the foregoing method embodiments, and details are not described again herein. In some embodiments provided by the present disclosure, it should be understood that the disclosed system, apparatus, and method may be implemented in other modes. For example, the apparatus embodiments as described above are only schematic, for example, the division of the units may be logical functional division; in actual implementation, there may be other division modes; for another example, a plurality of units or components may be combined or integrated into another system, or some features may be ignored or not executed. On the other hand, the displayed or discussed mutual coupling or direct coupling or communication connection may be implemented by using some communication interfaces. The indirect coupling or communication connection between the apparatuses or units may be implemented in electronic, mechanical, or other forms.

The above-mentioned units illustrated as separate components may be, or may not be physically separated, and the components displayed as units may be, or may not be, physical units, that is, they may be at one place, or may also be distributed to a plurality of network units; and some or all of the units may be selected according to actual needs to achieve the purpose of the solutions of the present embodiment.

In addition, the respective functional units in the respective embodiments of the present disclosure may be integrated in one processing unit, or each unit may physically exist separately, or two or more units may be integrated in one unit.

In the case where the functions are implemented in a form of software functional unit and sold or used as an independent product, the functions may be stored in a non-volatile computer-readable storage medium executable to the processor. Based on such understanding, the technical solutions of the present disclosure essentially, or part of the technical solutions may be implemented in a form of a software product. The computer software product is stored in a storage medium and includes several instructions so that a computer device (which may be a personal computer, a server, or a network device, etc.) to execute all or part of steps of the methods according to the respective embodiments of the present disclosure. The foregoing storage medium includes a USB flash disk, a removable hard disk, a Read-Only Memory (ROM), a Random-Access Memory (RAM), a magnetic disk or an optical disk, and various other media that can store program code.

If the technical solution of the present disclosure involves personal information, the product applying the technical solution of the present disclosure has clearly informed the personal information processing rules and obtained the individual's consent before processing the personal information. If the technical solution of the present disclosure involves sensitive personal information, the product applying the technical solution of the present disclosure has obtained the individual's consent before processing the sensitive personal information while meeting the requirement of “express consent”. For example, at a personal information collection apparatus such as a camera, a clear and conspicuous sign is set up to inform individuals that they have entered the area of personal information collection and that personal information will be collected, and individuals who voluntarily enter the area of collection are deemed to have consented to the collection of their personal information; or on a personal information processing apparatus, the personal information processing rules are informed with visible signs/information, authorization is acquired from individuals through pop-up messages or by asking the individuals to upload their personal information on their own. The personal information processing rules may include information on the person who processes personal information, the purpose of personal information processing, the processing manner, and the types of personal information to be processed.

Finally, it should be noted that the above-mentioned embodiments are only specific implementations of the present disclosure and used to illustrate the technical solutions of the present disclosure, and are not intended to limit the present disclosure; and the protection scope of the present disclosure is not limited thereto; although the present disclosure has been described in detail with reference to the foregoing embodiments, those ordinarily skilled in the art should understand that within the technical scope disclosed in the present disclosure, any person of skill familiar with the technical field can still modify or conceive of changes to the technical solutions recorded in the foregoing embodiments, or make equivalent substitutions for some of the technical features therein; and these modifications, changes or substitutions do not cause the essence of the corresponding technical solutions to deviate from the spirit and scope of the technical solutions of the embodiments of the present disclosure, all of which shall be covered within the protection scope of the present disclosure. Therefore, the protection scope of the present disclosure shall be subject to the protection scope of the claims.

1. An information search method, comprising:
in response to receiving a question message on an artificial intelligence (AI) dialogue interface, acquiring an aggregated answer result matching the question message, wherein the aggregated answer result is determined by content consumption modes corresponding to a message subject scope of the question message, the content consumption modes comprise a deep consumption mode and a broad consumption mode, and respective answer results in the aggregated answer result obtained in the broad consumption mode are capable of being consumed twice using the deep consumption mode; and
displaying the respective answer results comprised in the aggregated answer result on the AI dialogue interface.

2. The method according to claim 1, wherein after displaying the respective answer results comprised in the aggregated answer result, the method further comprises:
displaying a plurality of guiding icons below a target answer result, wherein different guiding icons are used for result consumption of the target answer result in different functional dimensions.

3. The method according to claim 2, wherein the guiding icons comprise a first icon having a result content interpretation function; and
after displaying the plurality of guiding icons, the method further comprises:
acquiring result content interpretation information matching the first icon, wherein the result content interpretation information is generated using an AI model according to the target answer result, and is used for parsing the target answer result; and
displaying the result content interpretation information.

4. The method according to claim 2, wherein the guiding icons comprise a second icon having an information recommendation function;
after displaying the plurality of guiding icons, the method further comprises:
in response to triggering the second icon, acquiring a plurality of recommended question messages associated with the target answer result, wherein the recommended question messages are generated using an AI model according to the target answer result and the question message; and
displaying the plurality of recommended question messages; and
after displaying the plurality of recommended question messages, the method further comprises:
displaying any recommended question message that is triggered as a new question message on the AI dialogue interface, and displaying a new aggregated answer result matching the new question message.

5. The method according to claim 2, wherein the guiding icons comprise a third icon having a result deletion function; and
after displaying the plurality of guiding icons, the method further comprises:
in response to triggering the third icon, deleting the target answer result, and updating display positions of respective answer results, other than the target answer result, in the aggregated answer result; or
in response to triggering the third icon, deleting the target answer result and a corresponding associated answer result, and updating display positions of respective answer results, other than the target answer result and the associated answer result, in the aggregated answer result,
wherein the associated answer result is an answer result in the aggregated answer result that has a result relevance greater than a preset relevance with the target answer result.

6. The method according to claim 1, wherein the aggregated answer result is determined by the following steps:
determining a scope index for indicating the message subject scope of the question message according to information semantics of the question message using an AI model; and
in response to the scope index being less than a preset index, aggregating answer results matching the question message from a plurality of information source channels according to the information semantics of the question message, to obtain the aggregated answer result.

7. The method according to claim 6, further comprising:
in response to the scope index being greater than or equal to the preset index, determining respective consumption directions corresponding to the question message according to the information semantics of the question message;
generating, for any consumption direction, an answer result matching the consumption direction according to the information semantics; and
determining the aggregated answer result according to answer results matching the respective consumption directions.

8. The method according to claim 6, further comprising:
in response to the scope index being greater than or equal to the preset index, filtering out the aggregated answer result from an information list corresponding to a main object indicated by the information semantics of the question message.

9. A computer device, comprising a processor and a memory, wherein the memory stores machine-readable instructions executable by the processor, the processor is configured to execute the machine-readable instructions stored in the memory, and when the machine-readable instructions are executed by the processor, the processor performs an information search method, which comprises:
in response to receiving a question message on an artificial intelligence (AI) dialogue interface, acquiring an aggregated answer result matching the question message, wherein the aggregated answer result is determined by content consumption modes corresponding to a message subject scope of the question message, the content consumption modes comprise a deep consumption mode and a broad consumption mode, and respective answer results in the aggregated answer result obtained in the broad consumption mode are capable of being consumed twice using the deep consumption mode; and
displaying the respective answer results comprised in the aggregated answer result on the AI dialogue interface.

10. The computer device according to claim 9, wherein after displaying the respective answer results comprised in the aggregated answer result, the information search method further comprises:
displaying a plurality of guiding icons below a target answer result, wherein different guiding icons are used for result consumption of the target answer result in different functional dimensions.

11. The computer device according to claim 10, wherein the guiding icons comprise a first icon having a result content interpretation function; and
after displaying the plurality of guiding icons, the information search method further comprises:
acquiring result content interpretation information matching the first icon, wherein the result content interpretation information is generated using an AI model according to the target answer result, and is used for parsing the target answer result; and
displaying the result content interpretation information.

12. The computer device according to claim 10, wherein the guiding icons comprise a second icon having an information recommendation function;
after displaying the plurality of guiding icons, the information search method further comprises:
in response to triggering the second icon, acquiring a plurality of recommended question messages associated with the target answer result, wherein the recommended question messages are generated using an AI model according to the target answer result and the question message; and
displaying the plurality of recommended question messages; and
after displaying the plurality of recommended question messages, the information search method further comprises:
displaying any recommended question message that is triggered as a new question message on the AI dialogue interface, and displaying a new aggregated answer result matching the new question message.

13. The computer device according to claim 10, wherein the guiding icons comprise a third icon having a result deletion function; and
after displaying the plurality of guiding icons, the information search method further comprises:
in response to triggering the third icon, deleting the target answer result, and updating display positions of respective answer results, other than the target answer result, in the aggregated answer result; or
in response to triggering the third icon, deleting the target answer result and a corresponding associated answer result, and updating display positions of respective answer results, other than the target answer result and the associated answer result, in the aggregated answer result,
wherein the associated answer result is an answer result in the aggregated answer result that has a result relevance greater than a preset relevance with the target answer result.

14. The computer device according to claim 9, wherein the aggregated answer result is determined by the following steps:
determining a scope index for indicating the message subject scope of the question message according to information semantics of the question message using an AI model; and
in response to the scope index being less than a preset index, aggregating answer results matching the question message from a plurality of information source channels according to the information semantics of the question message, to obtain the aggregated answer result.

15. The computer device according to claim 14, wherein the information search method further comprises:
in response to the scope index being greater than or equal to the preset index, determining respective consumption directions corresponding to the question message according to the information semantics of the question message;
generating, for any consumption direction, an answer result matching the consumption direction according to the information semantics; and
determining the aggregated answer result according to answer results matching the respective consumption directions.

16. The computer device according to claim 14, wherein the information search method further comprises:
in response to the scope index being greater than or equal to the preset index, filtering out the aggregated answer result from an information list corresponding to a main object indicated by the information semantics of the question message.

17. A non-transitory computer-readable storage medium, storing a computer program, wherein when the computer program is executed by a computer device, the computer device performs an information search method, which comprises:
in response to receiving a question message on an artificial intelligence (AI) dialogue interface, acquiring an aggregated answer result matching the question message, wherein the aggregated answer result is determined by content consumption modes corresponding to a message subject scope of the question message, the content consumption modes comprise a deep consumption mode and a broad consumption mode, and respective answer results in the aggregated answer result obtained in the broad consumption mode are capable of being consumed twice using the deep consumption mode; and
displaying the respective answer results comprised in the aggregated answer result on the AI dialogue interface.

18. The non-transitory computer-readable storage medium according to claim 17, wherein after displaying the respective answer results comprised in the aggregated answer result, the information search method further comprises:
displaying a plurality of guiding icons below a target answer result, wherein different guiding icons are used for result consumption of the target answer result in different functional dimensions.

19. The non-transitory computer-readable storage medium according to claim 18, wherein the guiding icons comprise a first icon having a result content interpretation function; and
after displaying the plurality of guiding icons, the information search method further comprises:
acquiring result content interpretation information matching the first icon, wherein the result content interpretation information is generated using an AI model according to the target answer result, and is used for parsing the target answer result; and
displaying the result content interpretation information.

20. The non-transitory computer-readable storage medium according to claim 18, wherein the guiding icons comprise a second icon having an information recommendation function;
after displaying the plurality of guiding icons, the information search method further comprises:
in response to triggering the second icon, acquiring a plurality of recommended question messages associated with the target answer result, wherein the recommended question messages are generated using an AI model according to the target answer result and the question message; and
displaying the plurality of recommended question messages; and
after displaying the plurality of recommended question messages, the information search method further comprises:
displaying any recommended question message that is triggered as a new question message on the AI dialogue interface, and displaying a new aggregated answer result matching the new question message.
